(19) United States
(12) Patent Application Publication
(10) Pub. No.: US 2005/0258799 A1
(43) Pub. Date: Nov. 24, 2005

(54) Universal mobile power pack

(76) Inventor: Hugo Escobar, Sacramento, CA (US)

Correspondence Address: MICHAEL A. GUTH, 2-2905 EAST CLIFF DRIVE, SANTA CRUZ, CA, 95062, US

(21) Appl. No.: 10/852,687

(22) Filed: May 24, 2004

(51) Int. Cl. H01R 3/00

(52) U.S. Cl. 320/107

(57) ABSTRACT

An auxiliary power supply for electronic devices such as cellular telephones and personal digital assistants. The power supply is adapted to be able to supply many types of devices utilizing multiple connector modules. The power supply comprises and intermediate portion adapted to receive different connector modules. The intermediate portion may receive a battery or have a battery housed within it.

### BACKGROUND

1. Field of the Invention

This invention is related generally to the field of power supplies and more specifically to an auxiliary power supply for cellular telephones and other electronic devices.

2. Description of Related Art

A variety of different battery-operated tools and other consumer products currently are available on the market. Typically, these products are powered by rechargeable batteries or rechargeable battery packs. With some products, batteries are removed from the devices and placed in a charger. Other devices, such as cellular telephones, include a power converter that can be used in place of the battery to operate the telephone. Typical of these converters are converters which plug into an automobile's cigarette lighter, or which plug into an AC power outlet in the home.

Cellular telephones typically have a main rechargeable battery, which can be comprised of a series of electrochemical cells in series or in parallel, and the main battery provides electricity to the functioning components of the cellular telephone. Once the main battery has discharged its energy, the cellular telephone can no longer send or receive transmissions. Most cellular telephones have a power level indicator or other warning device to alert the user of the cellular telephone of the remaining charge on the telephone and if a power failure is imminent.

However, the onset of the complete discharge of the main battery can occur very quickly when the cellular is actively being used for communication. The user may end up with a dead battery, which is a serious problem if that user then needs to make an emergency telephone call. If there is not another power source, the cellular telephone will remain inoperable.

What is called for is an auxiliary power supply that can be utilized when an electronic device's primary battery power source is exhausted. In addition, given the variety of electrical connector types on the different electronic devices, a versatile power supply would support a variety of such connector types is called for.

### SUMMARY

An auxiliary power supply for electronic devices such as cellular telephones and personal digital assistants. The power supply is modular and is adapted to be able to supply many types of devices utilizing different connector modules. The power supply comprises an intermediate portion adapted to receive different connector modules. The intermediate portion may receive a battery or have a battery housed within it.

BRIEF DESCRIPTION OF THE DRAWINGS

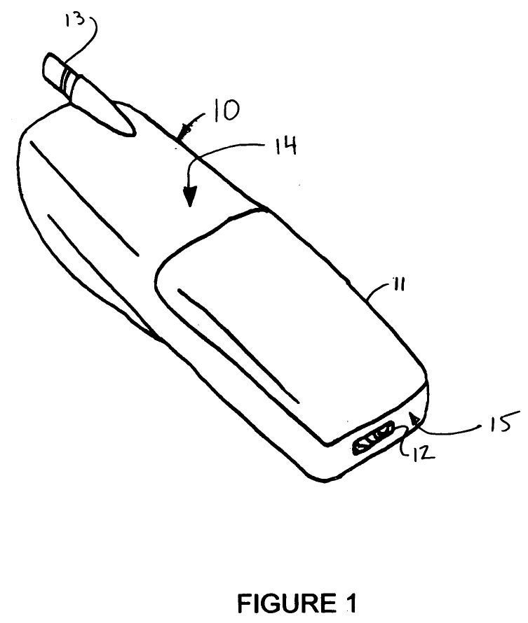

FIG. 1 is a pictorial representation of a cellular telephone.

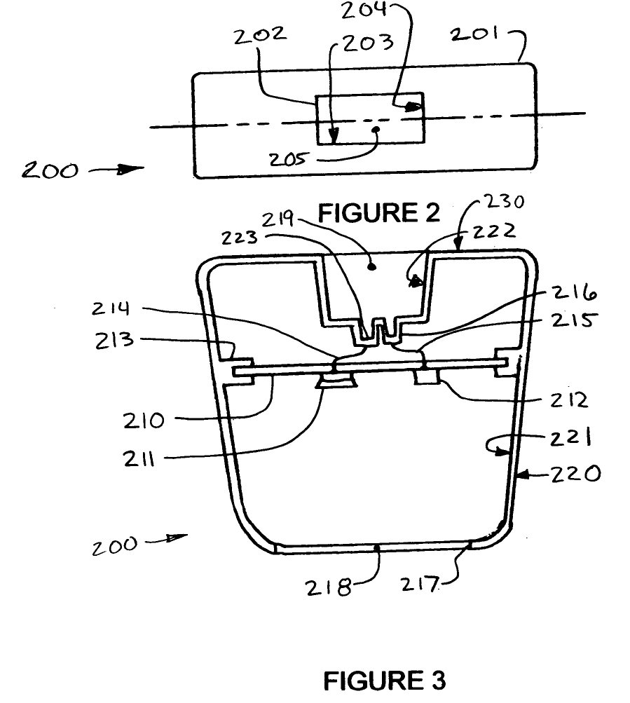

FIG. 2 is a top view of one embodiment of the intermediate portion of the power supply.

FIG. 3 is a cross-sectional view of one embodiment of the intermediate portion of the power supply.

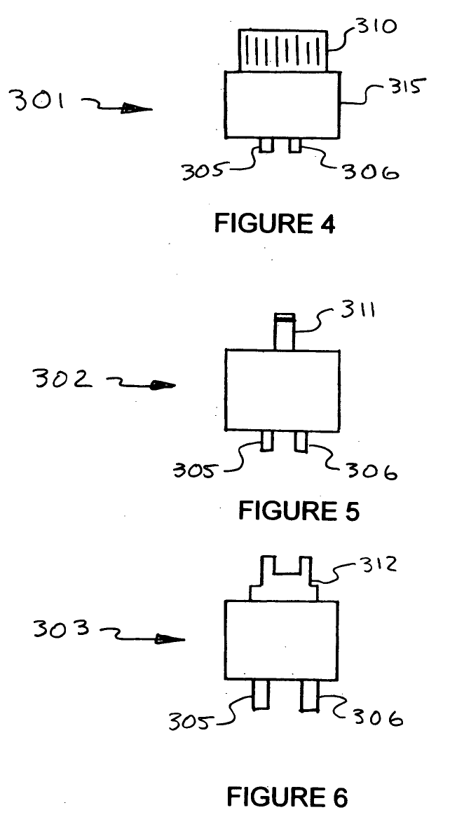

FIG. 4 is a side view of one embodiment of the connector portion.

FIG. 5 is a side view of one embodiment of the connector portion.

FIG. 6 is a side view of one embodiment of the connector portion.

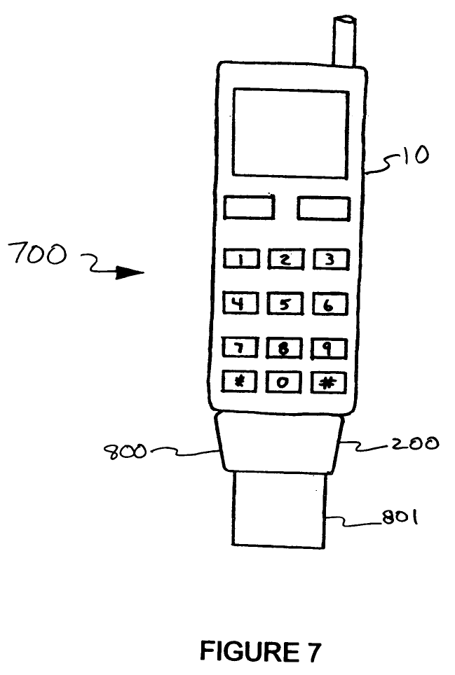

FIG. 7 is a pictorial view of one embodiment of the power supply engaged to a cellular telephone.

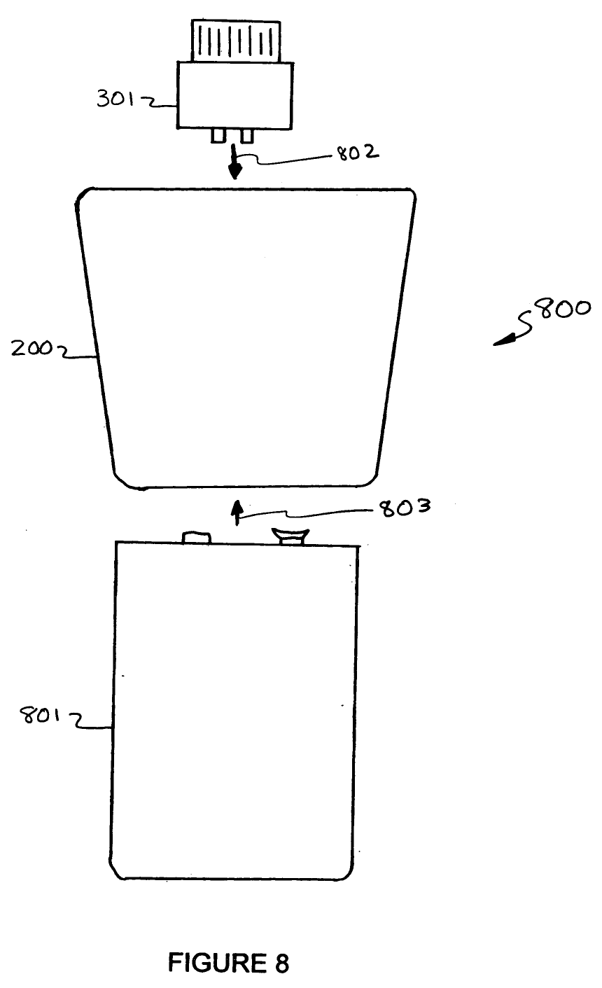

FIG. 8 is an exploded view sketch of one embodiment of the power supply.

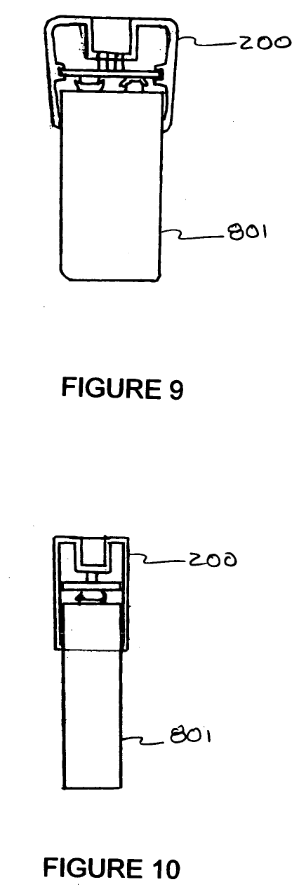

FIG. 9 is a cross-sectional side view of one embodiment of the power supply.

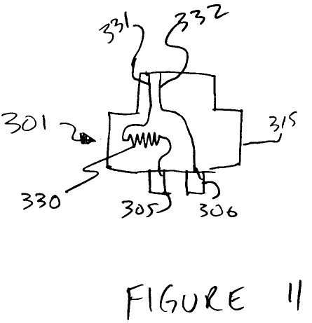

FIG. 10 is a cross-sectional end view of one embodiment of the power supply.

FIG. 11 is figurative representation of a connector portion according to one embodiment of the present invention.

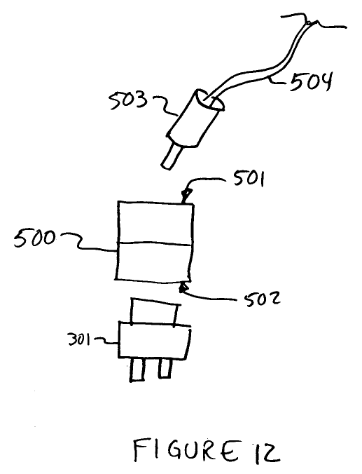

FIG. 12 is pictorial representation of a bridge plug according to one embodiment of the present invention.

### DETAILED DESCRIPTION

FIG. 1 illustrates a typical example of an electronic device. Cellular telephone 10 is shown with back surface 14 and antenna 13. The battery cover 11 is typically removable and allows access to the cellular telephone's primary battery (not shown). Connection jack 12 is typically on the bottom surface 15 of cellular telephone 10. Connection jack 12 typically provides electrical connection for cellular telephone 10 to auxiliary power such as an AC charger, to a separate antennae, and to other devices.

In one embodiment of the present invention, as seen in FIG. 2, intermediate portion 200 is shown in top view. Intermediate portion main body 201 has a first opening 205 which is adapted to receive a connector portion. The intermediate portion main body first opening 205 has side walls 203, 204 which form first opening 205.

In one embodiment of the present invention, as seen in FIG. 3, intermediate portion 200 is shown in a sectional view. Intermediate portion 200 has a second opening 218 which is sized to allow the insertion of a battery (not shown). Second opening 218 is formed by lower walls 217. In some embodiments, the second opening 218 is sized to allow the insertion of a battery of standard nine volt transistor battery size and shape. Intermediate portion 200 is substantially hollow in some embodiments. Main body outer surface 200 and main body inner surface 221 substantially form the shape of the intermediate portion 200. In some embodiments, intermediate portion 200 is made of plastic or other suitable materials. In some embodiments, intermediate portion 200 has clips 213 formed into the inner surface 221. Clips 213 hold platform 211 in place within the intermediate portion 200. Battery contacts 211, 212 are mounted onto the platform 210 in some embodiments. The battery contacts 211, 212 are configured to mount to a standard 9 volt battery in this embodiment. Battery contact 211 is electrically coupled to connector module contact 223 via wire 214 in this embodiment. Battery contact 212 is electrically coupled to connector module contact 216 via wire 215 in this embodiment. Intermediate portion first opening 219 is an opening in the top surface 230 of intermediate portion 200 in this embodiment. Intermediate portion first opening wall 222 may be perpendicular to surface 230 or another angle in some embodiments. The connector module contacts 216, 223 are adapted to electrically connect to the connector portion. The intermediate portion first opening 219 is adapted to physically couple the intermediate portion 200 to the connector portion 301, 302, 303.

In some embodiments, the battery 801 will be wholly contained within the intermediate portion 200. In some embodiments, only the top surface or portions of the top surface of the battery 801 will be contained within the intermediate portion 200.

In some embodiments, as seen in FIGS. 4, 5, and 6, the connector portion 301, 302, 303, have a connector body 315 and connector portion contacts 305, 306 to allow the connector portion 301, 302, 303 to be electrically connected and physically coupled to the intermediate portion 200. The device connector 310, 311, 312 is adapted to physically couple and electrically connect the device connector to the connection jack 12 of an electronic device such as a cellular telephone.

FIG. 7 illustrates one embodiment of the present invention attached to a cellular telephone. Alternatively powered cellular telephone system 700 uses power supply 800 to power cellular telephone 10. The battery 801 is coupled to the intermediate portion 200 in this embodiment. The intermediate portion 200 is attached to the cellular telephone 10 via the connector portion (hidden in this view).

FIG. 8 is an exploded view of one embodiment 800 of the present invention. In this embodiment, battery 801 is inserted into the intermediate portion 200 along the line of the arrow 803. The connector portion 301 is inserted into the intermediate portion 200 along the line of the arrow 802. When the connector portion 301 and the battery 801 are inserted into the intermediate portion 200 to create power supply 800, power supply 800 may connected to an electronic device such as a cellular telephone or a personal digital assistant. The power supply 800 can then supply electrical power to the electronic device even if the internal battery of the electronic device is depleted.

In some embodiments of the present invention, as seen in FIGS. 9 and 10, battery 801 is mounted within intermediate portion 200. Battery 801 is a nine volt transistor battery in some embodiments. In some embodiments, battery 801 is a rechargeable battery. In some embodiments, battery 801 is a NiCd rechargeable battery. In some embodiments, battery 801 is a NiMH rechargeable battery.

FIG. 11 shows a cross-sectional view of connector portion 301 according to some embodiments of the present invention. The connector portion 301 has connector body 315 and connector portion contacts 305, 306 to allow the connector portion 301 to be electrically connected and physically coupled to the intermediate portion 200. The electronic device contacts 331, 332 provide electrical contact between the connector portion 301 and the electronic device. Because different electrical devices that are to powered may have different voltage requirements, connector portion resistor 330 may be connected in-line between the connector portion contact 305 and the electronic device contact 331 in some embodiments. The resistance value of the connector portion resistor 330 will vary according to the needs of a particular electronic device.

In some embodiments of the present invention, a battery charge LED may be used. The battery charge LED is used to indicate the charge status of the battery.

In some embodiments of the power supply 800, the battery 801 is a rechargeable battery. Bridge plug 500 is utilized to recharge battery 801 while battery 801 remains in the power supply 800. As seen in FIG. 12, charge cord 504 routes to a power supply (not shown). Battery charge connector 503 is electrically coupled to the charge cord 504. The bridge plug 500 is adapted to physically and electrically couple to the battery charge connector 503. In some embodiments, the battery charge connector 503 couples to the bridge plug 500 through the top surface 501 of the bridge plug 500.

The bridge plug 500 is adapted to electrically and physically couple to the connector portion 301. Different embodiments of the bridge plug 500 may be used depending upon the configuration of the connector portion used in a particular application. In some embodiments, the bridge plug 500 is coupled to the connector portion through the bottom surface 502 of the bridge plug 500.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

1. A power supply comprising:
an intermediate portion, and
a connector portion, said connector portion adapted to plug into said intermediate portion, said intermediate portion adapted to plug into an electronic device, wherein said intermediate portion is physically coupled and electronically coupled-to said connector portion.

2. The power supply of claim 1 wherein said electronic device is a cellular telephone.

3. The power supply of claim 1 wherein said electronic device is a personal digital assistant.

4. The power supply of claim 1 wherein said intermediate portion is adapted to receive a battery.

5. The power supply of claim 4 wherein said battery is of standard nine volt size and shape.

6. The power supply of claim 1 wherein said intermediate portion comprises:
a first opening adapted to receive a connector portion, and
a second opening adapted to receive a battery.

7. The power supply of claim 6 where said second opening is adapted to receive a battery of standard nine volt size and shape.

8. The power supply of claim 1 wherein said intermediate portion comprises:
a main body, and
a battery.

9. The power supply of claim 8 wherein said battery is a rechargeable battery.

10. The power supply of claim 1 further comprising a battery.

11. The power supply of claim 10 wherein said battery is a rechargeable battery.

12. The power supply of claim 11 wherein said rechargeable battery is NiMH battery.

13. The power supply of claim 10 wherein said battery is of standard nine volt size and shape.

14. The power supply of claim 1 wherein said intermediate portion is adapted to couple to one of a plurality of connector portions, wherein said plurality of connector portions are adapted to electrically couple and physically couple said connector portions to different electronic devices.

15. The power supply of claim 1 wherein said connector portion comprises:
a first set of electrical contacts disposed to electrically couple said connector portion to an electronic device,
a second set of electrical contacts disposed to electrically couple said connector portion to said intermediate portion, and
wiring to electrically couple said first set of contacts to said second set of contacts.

16. The power supply of claim 1 wherein said connector portion further comprises a resistor, said resistor electrically in line between one of said first set of electrical contacts and one of said second set of electrical contacts.

17. The power supply of claim 1 further comprising a bridge plug, said bridge plug adapted to physically and electrically connect to said connector portion, said bridge plug adapted to physically and electrically connect to the plug of a power supply.
